(19) United States
(12) Patent Application Publication
(10) Pub. No.: US 2023/0149808 A1
(43) Pub. Date: May 18, 2023

(54) METHOD FOR PROVIDING BATTLE ROYALE GAME WHICH FORWARDS SUPPLY BOXES AND SERVER USING THE SAME

(71) Applicant: Wonder People Co., Ltd., Seoul (KR)

(72) Inventor: Min HUR, Seoul (KR)

(21) Appl. No.: 17/972,088

(22) Filed: Oct. 24, 2022

(30) Foreign Application Priority Data
Nov. 16, 2021 (KR) 10-2021-0158087
Jun. 16, 2022 (KR) 10-2022-0073834

(51) Int. Cl. A63F 13/45; A63F 13/35; A63F 13/44

(52) U.S. Cl. CPC A63F 13/45; A63F 13/35; A63F 13/44

(57) ABSTRACT

A battle royale game is provided to forward a supply box. A method for providing the battle royale game includes steps of: (a) confirming specific supply box forwarding timing candidates and specific timing probabilities corresponding thereto, wherein the specific supply box forwarding timing candidates match with the specific game-progression degree; and (b) forwarding the supply box to a supply box forwarding spot at a specific supply box forwarding timing, to thereby support players to acquire supply items contained in the supply box, wherein the specific supply box forwarding timing is calculated by a predetermined 1-st function having arguments of the specific supply box forwarding timing candidates and the specific timing probabilities and wherein the supply box forwarding spot is calculated by a predetermined 2-nd function having arguments of the area metadata, playing locations of the players on a map, and designated locations by the players.

### CROSS REFERENCE OF RELATED APPLICATION

This present application claims the benefit of the earlier filing date of Korean Provisional Patent Application No. 10-2021-0158087, filed Nov. 16, 2021, and Korean Patent Application No. 10-2022-0073834, filed on Jun. 16, 2022, the entire contents of which being incorporated herein by reference.

### FIELD OF THE DISCLOSURE

The present disclosure relates to a method for providing a battle royale game; and more particularly, to the method for providing the battle royale game which forwards supply boxes, and the server using the same.

### BACKGROUND OF THE DISCLOSURE

Numerous battle royale games which can be played by multiple users at the same time are recently being released, and are gaining popularity steadily from the users. Accordingly, the field of the battle royale games is rapidly growing.

Such battle royale games are allowing the multiple players to compete for survival to be a final winner in a restricted space, and the users feel interest in preoccupying items and geographical advantages and establishing appropriate strategies or tactics according thereto, thereby overpowering competitors.

Under the circumstances, a game server may provide a supply box(s) containing at least one item in order to impart more feel of interest to the users and support the users to overturn any disadvantageous battle situation by using the supply box. Herein, conventionally, the supply box containing an item randomly determined is provided to a random spot at a random timing.

However, considering the powerful influence of the item contained in the supply box, a way of providing of the supply box containing the randomly determined item to the random spot at the random timing may cause a unreasonable case in which a probability of a survival of a user being determined by only a coincidental element, e.g., the supply box, becomes highly considerable in the battle royale game. But, in general, many players do not want to depend only on whether they acquire the supply boxes but want to fiercely compete for survival through well-established strategies.

Thus, there may be a problem of letting many users think that there is no need to establish any strategies because the most important factor of winning the game is highly related to whether the users can acquire the supply boxes or not.

Therefore, an enhanced method for solving the aforementioned problems is required.

### SUMMARY OF THE DISCLOSURE

It is an object of the present disclosure to solve all the aforementioned problems.

It is another object of the present disclosure to determine a forwarding timing and a forwarding spot of a supply box in a battle royale game by referring to information on various situations in the battle royale game.

It is still another object of the present disclosure to allow players participating in the battle royale game to continuously have interests in the battle royale game.

In accordance with one aspect of the present disclosure, there is provided a method for providing a battle royale game which forwards a supply box, wherein the battle royale game is a game in which a plurality of players compete for survival in a specific area, wherein a first state of the battle royale game represents a state in which the players log into the battle royale game but do not play the battle royale game and wherein a second state of the battle royale game represents a state in which the players play the battle royale game, including steps of: (a) on condition that each of supply box forwarding timing candidates for each of game-progression degrees and each of timing probabilities corresponding thereto are set and managed, each of the game-progression degrees is calculated by using a progress calculating function having arguments of at least part of (i) elapsed time information which represents a time elapsed after the battle royale game enters the 2-nd state, (ii) player battle power information which represents a battle power of at least part of the plurality of players, (iii) area phase information which represents a state of a safe area and a dangerous area being changed according to area metadata, (iv) a cardinal number of surviving players among the plurality of players and (v) possessed item of the surviving players, in response to determining that specific game-progression degree acquired by the progress calculating function in real-time in the 2-nd state satisfies a preset condition, a server confirming specific supply box forwarding timing candidates and specific timing probabilities corresponding thereto, wherein the specific supply box forwarding timing candidates match with the specific game-progression degree; and (b) the server forwarding the supply box to a supply box forwarding spot at a specific supply box forwarding timing, to thereby support at least part of the plurality of players to acquire at least one supply item contained in the supply box, wherein the specific supply box forwarding timing is calculated by a predetermined 1-st function having arguments of the specific supply box forwarding timing candidates and the specific timing probabilities and wherein the supply box forwarding spot is calculated by a predetermined 2-nd function having arguments of at least part of the area metadata, playing locations of at least part of the players on a map, and designated locations by at least part of the players.

As one example, there is provided a method, wherein, at the step of (b), the server forwards at least part of a 1-st type supply box and a 2-nd type supply box to at least part of a 1-st type supply box forwarding spot and a 2-nd type supply box forwarding spot at the specific supply box forwarding timing, to thereby support at least one 1-st player among the plurality of players to acquire at least part of a (1_1)-st supply item and a (1_2)-nd supply item contained in the 1-st type supply box, or support at least part of the plurality of players to acquire at least part of a (2_1)-st supply item and a (2_2)-nd supply item contained in the 2-nd type supply box, wherein the 1-st type supply box contains at least part of the (1_1)-st supply item determined by the 1-st player in the 1-st state and the (1_2)-nd supply item determined by the 1-st player in the 2-nd state, and wherein the 2-nd type supply box contains at least part of the (2_1)-st supply item determined by the server in the 1-st state and the (2_2)-nd supply item determined by the server in the 2-nd state, and wherein each of the 1-st type supply box and the 2-nd type supply box is forwarded to each of the 1-st type supply box forwarding spot and the 2-nd type supply box forwarding spot defined as the supply box forwarding spot by the predetermined 2-nd function having arguments of at least part of the area metadata, the playing locations of at least part of the players on the map and the designated locations by at least part of the players.

As one example, there is provided a method, wherein the 1-st type supply box contains, as the supply item, at least part of a (1_1)-st class synergy item determined by the first player in the 1-st state and a (1_2)-nd class synergy item determined by the first player in the 2-nd state among 1-st class synergy items corresponding to a 1-st class applied to the 1-st player, wherein the 1-st class synergy item is an item of which a performance is improved when used by the 1-st player to whom the 1-st class applies among at least one class which applies to the plurality of players, and wherein the 2-nd type supply box contains at least part of a (2_1)-st item determined by the server in the 1-st state and a (2_2)-nd item determined by the server in the 2-nd state, among items used in the battle royale game, based on at least part of specific elapsed time information, specific player battle power information, specific area phase information, a specific cardinal number of surviving players and a specific possessed item of a specific surviving player.

As one example, there is provided a method, wherein, at the step of (b), the server performs at least part of (i) a process of forwarding the 1-st type supply box to the 1-st type supply box forwarding spot at the specific supply box forwarding timing, and (i-1) supporting at least part of the 1-st player to acquire at least part of the (1_1)-st supply item and the (1_2)-nd supply item contained the 1-st type supply box according to a (1_1)-st mode in which information on the specific supply box forwarding timing and the 1-st type supply box forwarding spot is not provided to the 1-st player; or (i-2) supporting at least part of the 1-st player to acquire at least part of the (1_1)-st supply item and the (1_2)-nd supply item contained the 1-st type supply box by providing information on the specific supply box forwarding timing to at least part of the 1-st player according to a (1_2)-nd mode in which the information on the specific supply box forwarding timing is provided to at least part of the 1-st player; or (i-3) supporting at least part of the 1-st player to acquire at least part of the (1_1)-st supply item and the (1_2)-nd supply item contained the 1-st type supply box by providing the information on the 1-st type supply box forwarding spot to at least part of the 1-st player according to a (1_3)-rd mode in which the information on the 1-st type supply box forwarding spot is provided to at least part of the 1-st player; or (i-4) supporting at least part of the 1-st player to acquire at least part of the (1_1)-st supply item and the (1_2)-nd supply item contained the 1-st type supply box by providing information on the specific supply box forwarding timing and the 1-st type supply box forwarding spot to at least part of the 1-st player according to a (1_4)-th mode in which the information on the specific supply box forwarding timing and the 1-st type supply box forwarding spot is provided to at least part of the 1-st player; and (ii) a process of forwarding the 2-nd type supply box to the 2-nd type supply box forwarding spot at the specific supply box forwarding timing, and (ii-1) supporting the plurality of players to acquire at least part of the (2_1)-st supply item and the (2_2)-nd supply item contained in the 2-nd type supply box according to a (2_1)-st mode in which the information on the specific supply box forwarding timing and the 2-nd type supply box forwarding spot is not provided to the plurality of players; or (ii-2) supporting at least part of the plurality of players to acquire at least part of the (2_1)-st supply item and the (2_2)-nd supply item contained in the 2-nd type supply box by providing the information on the specific supply box forwarding timing to at least part of the plurality of players according to a (2_2)-nd mode in which the information on the specific supply box forwarding timing is provided to at least part of the plurality of players; or (ii-3) supporting at least part of the plurality of players to acquire at least part of the (2_1)-st supply item and the (2_2)-nd supply item contained the 2-nd type supply box by providing the information on the 2-nd type supply box forwarding spot to at least part of the plurality of players according to (2_3)-rd mode in which the information on the 2-nd type supply box forwarding spot is provided to at least part of the plurality of players; or (ii-4) supporting at least part of the plurality of players to acquire at least part of the (2_1)-st supply item and the (2_2)-nd supply item contained the 2-nd type supply box by providing information on the specific supply box forwarding timing and the 2-nd type supply box forwarding spot to at least part of the plurality of players according to (2_4)-th mode in which the information on the specific supply box forwarding timing and the 2-nd type supply box forwarding spot is provided to at least part of the plurality of players.

As one example, there is provided a method, wherein, at the step of (b), the server performs at least part of (i) a process of (i-1) providing at least part of the information on the specific supply box forwarding timing and the 1-st type supply box forwarding spot to at least part of the 1-st player according to any one of the (1_2)-nd mode to the (1_4)-th mode, (i-2) supporting at least part of the 1-st player to display at least part of the information on the specific supply box forwarding timing and the 1-st type supply box forwarding spot through at least part of a 1-st display area for displaying azimuth information, a 2-nd display area for displaying field information, a 3-rd display area for displaying map information and a 4-th display area for displaying visual information, and thus (i-3) supporting at least part of the 1-st player to acquire at least part of the (1_1)-st supply item and the (1_2)-nd supply item contained the 1-st type supply box; and (ii) a process of (ii-1) providing at least part of the information on the specific supply box forwarding timing and the 2-nd type supply box forwarding spot to at least part of the plurality of players according to any one of the (2_2)-nd mode to the (2_4)-th mode, (ii-2) supporting at least part of the plurality of players to display at least part of information on the specific supply box forwarding timing and the 2-nd type supply box forwarding spot through at least part of the 1-st display area, the 2-nd display area, the 3-rd display area and the 4-th display area, and thus (ii-3) supporting at least part of the plurality of players to acquire at least part of the (2_1)-st supply item and the (2_2)-nd supply item contained the 2-nd type supply box.

As one example, there is provided a method, wherein, at the step of (a), on condition that metadata on at least part of a 1-st weight applied to the elapsed time information, a 2-nd weight applied to the player battle power information, a 3-rd weight applied to the area phase information, a 4-th weight applied to the cardinal number of the surviving players and a 5-th weight applied to the possessed item of the surviving players are managed, the server acquires weighted specific game-progression degree by applying at least part of the 1-st weight to the 5-th weight to at least part of specific elapsed time information, specific player battle power information, specific area phase information, specific cardinal number of the surviving players and a specific possessed item of a specific surviving player, and confirms the specific supply box forwarding timing candidates and specific timing probabilities corresponding thereto, wherein the specific supply box forwarding timing candidates match with the weighted specific game-progression degree.

As one example, there is provided a method, wherein, at the step of (a), the server determines a specific factor whose rate of change in a specific time section is more than or equal to a threshold rate of change among total factors comprised of the player battle power information, the area phase information, the cardinal number of the surviving players and the possessed item of the surviving players, wherein the specific time section corresponds to a specific timing when the specific game-progression degree is acquired among a predetermined plurality of time sections, and the server sets a specific weight corresponding to the specific factor to be greater than other weights corresponding to other factors, wherein said other factors are factors excluding the specific factor among the total factors.

As one example, there is provided a method, wherein, at the step of (a), the game-progression degree is calculated by the progress calculating function having arguments of at least part of (i) the elapsed time information, (ii) the player battle power information, (iii) the area phase information, (iv) the cardinal number of the surviving players, (v) the possessed item of the surviving players, (vi) location distribution information of the supply box previously forwarded in the field in the battle royale game and (vii) location distribution information of the surviving players, and in response to determining that the specific game-progression degree acquired by the progress calculating function in real-time in the 2-nd state satisfies the preset condition, the game server confirming the specific supply box forwarding timing candidates and the specific timing probabilities corresponding thereto.

As one example, there is provided a method, wherein, at the step of (b), the server (i) determines a 1-st surviving player group to an n-th surviving player group by further referring to at least part of class information on a class applied to a specific surviving player and a specific possessed item of the specific surviving player, and (ii) forwards each of a 1-st matching supply box to an n-th matching supply box matching to each of the 1-st surviving player group to the n-th surviving player group to each of a 1-st supply box forwarding spot to an n-th supply box forwarding spot determined based on locations of each of the 1-st surviving player group to the n-th surviving player group at each of a 1-st specific supply box forwarding timing to an n-th specific supply box forwarding timing, wherein each of the 1-st supply box forwarding spot to the n-th supply box forwarding spot is calculated by each of a predetermined (2_1)-st function to a predetermined (2_n)-th function, wherein the predetermined (2_1)-st function has arguments of at least part of the area metadata, playing locations of at least part of the 1-st surviving player group on a 1-st map and a 1-st designated location by at least part of the 1-st surviving player group and the predetermined (2_n)-th function has arguments of at least part of the area metadata, playing locations of at least part of the n-th surviving player group on an n-th map and an n-th designated location by at least part of the n-th surviving player group, and wherein each of the 1-st specific supply box forwarding timing to the n-th specific supply box forwarding timing is calculated by each of a predetermined (1_1)-st function to a predetermined (1_n)-th function, wherein the predetermined (1_1)-st function has arguments of a 1-st specific supply box forwarding timing candidates and 1-st specific timing probabilities corresponding thereto and the predetermined (1_2)-nd function has arguments of an n-th specific supply forwarding timing candidates and n-th specific timing probabilities corresponding thereto, and (iii) provides at least part of information on the 1-st supply box forwarding spot to the n-th supply box forwarding spot and the 1-st specific supply box forwarding timing and the n-th specific supply box forwarding timing to at least part of the 1-st surviving player group to the n-th surviving player group, thereby supporting at least part of the 1-st surviving player group to the n-th surviving player group to acquire the supply item.

As one example, there is provided a method, wherein, at the step of (b), the server forwards the supply box to the supply box forwarding spot at the specific supply box forwarding timing, wherein (i) a first item probability that a class synergy item among the supply items is contained in the supply box in case a ratio of at least one specific factor among total factors comprised of specific elapsed time information, specific player battle power information, specific area phase information, specific cardinal number of surviving players and a specific possessed item of a specific surviving player acquired in real-time is more than a specific threshold is greater than (ii) a second item probability that the class synergy item is contained in the supply box in case the ratio of the specific factor among the total factor is less than the threshold, wherein the specific threshold is determined corresponding to the specific supply box forwarding timing, and wherein the class synergy item is an item of which a performance is improved when used by a k-th specific surviving player to whom a k-th class is applied among classes applied to the surviving players, and is determined based on class information on the class applied to the specific surviving player and information on the specific possessed item of the specific surviving player.

In accordance with another aspect of the present disclosure, there is provided a server for providing a battle royale game which forwards a supply box, including steps of: at least one memory that stores instructions; and at least one processor configured to execute the instructions to perform or support another device to perform: processes of (I) on condition that each of supply box forwarding timing candidates for each of game-progression degrees and each of timing probabilities corresponding thereto are set and managed, each of the game-progression degrees is calculated by using a progress calculating function having arguments of at least part of (i) elapsed time information which represents a time elapsed after the battle royale game enters the 2-nd state, (ii) player battle power information which represents a battle power of at least part of the plurality of players, (iii) area phase information which represents a state of a safe area and a dangerous area being changed according to area metadata, (iv) a cardinal number of surviving players among the plurality of players and (v) possessed item of the surviving players, in response to determining that specific game-progression degree acquired by the progress calculating function in real-time in the 2-nd state satisfies a preset condition, confirming specific supply box forwarding timing candidates and specific timing probabilities corresponding thereto, wherein the specific supply box forwarding timing candidates match with the specific game-progression degree; and (II) forwarding the supply box to a supply box forwarding spot at a specific supply box forwarding timing, to thereby support at least part of the plurality of players to acquire at least one supply item contained in the supply box, wherein the specific supply box forwarding timing is calculated by a predetermined 1-st function having arguments of the specific supply box forwarding timing candidates and the specific timing probabilities and wherein the supply box forwarding spot is calculated by a predetermined 2-nd function having arguments of at least part of the area metadata, playing locations of at least part of the players on a map, and designated locations by at least part of the players.

As one example, there is provided a server, wherein, at the process of (II), the processor forwards at least part of a 1-st type supply box and a 2-nd type supply box to at least part of a 1-st type supply box forwarding spot and a 2-nd type supply box forwarding spot at the specific supply box forwarding timing, to thereby support at least one 1-st player among the plurality of players to acquire at least part of a (1_1)-st supply item and a (1_2)-nd supply item contained in the 1-st type supply box, or support at least part of the plurality of players to acquire at least part of a (2_1)-st supply item and a (2_2)-nd supply item contained in the 2-nd type supply box, wherein the 1-st type supply box contains at least part of the (1_1)-st supply item determined by the 1-st player in the 1-st state and the (1_2)-nd supply item determined by the 1-st player in the 2-nd state, and wherein the 2-nd type supply box contains at least part of the (2_1)-st supply item determined by the server in the 1-st state and the (2_2)-nd supply item determined by the server in the 2-nd state, and wherein each of the 1-st type supply box and the 2-nd type supply box is forwarded to each of the 1-st type supply box forwarding spot and the 2-nd type supply box forwarding spot defined as the supply box forwarding spot by the predetermined 2-nd function having arguments of at least part of the area metadata, the playing locations of at least part of the players on the map and the designated locations by at least part of the players.

As one example, there is provided a server, wherein the 1-st type supply box contains, as the supply item, at least part of a (1_1)-st class synergy item determined by the first player in the 1-st state and a (1_2)-nd class synergy item determined by the first player in the 2-nd state among 1-st class synergy items corresponding to a 1-st class applied to the 1-st player, wherein the 1-st class synergy item is an item of which a performance is improved when used by the 1-st player to whom the 1-st class applies among at least one class which applies to the plurality of players, and wherein the 2-nd type supply box contains at least part of a (2_1)-st item determined by the server in the 1-st state and a (2_2)-nd item determined by the server in the 2-nd state, among items used in the battle royale game, based on at least part of specific elapsed time information, specific player battle power information, specific area phase information, a specific cardinal number of surviving players and a specific possessed item of a specific surviving player.

As one example, there is provided a server, wherein, at the process of (II), the processor performs at least part of (i) a process of forwarding the 1-st type supply box to the 1-st type supply box forwarding spot at the specific supply box forwarding timing, and (i-1) supporting at least part of the 1-st player to acquire at least part of the (1_1)-st supply item and the (1_2)-nd supply item contained the 1-st type supply box according to a (1_1)-st mode in which information on the specific supply box forwarding timing and the 1-st type supply box forwarding spot is not provided to the 1-st player; or (i-2) supporting at least part of the 1-st player to acquire at least part of the (1_1)-st supply item and the (1_2)-nd supply item contained the 1-st type supply box by providing information on the specific supply box forwarding timing to at least part of the 1-st player according to a (1_2)-nd mode in which the information on the specific supply box forwarding timing is provided to at least part of the 1-st player; or (i-3) supporting at least part of the 1-st player to acquire at least part of the (1_1)-st supply item and the (1_2)-nd supply item contained the 1-st type supply box by providing the information on the 1-st type supply box forwarding spot to at least part of the 1-st player according to a (1_3)-rd mode in which the information on the 1-st type supply box forwarding spot is provided to at least part of the 1-st player; or (i-4) supporting at least part of the 1-st player to acquire at least part of the (1_1)-st supply item and the (1_2)-nd supply item contained the 1-st type supply box by providing information on the specific supply box forwarding timing and the 1-st type supply box forwarding spot to at least part of the 1-st player according to a (1_4)-th mode in which the information on the specific supply box forwarding timing and the 1-st type supply box forwarding spot is provided to at least part of the 1-st player; and (ii) a process of forwarding the 2-nd type supply box to the 2-nd type supply box forwarding spot at the specific supply box forwarding timing, and (ii-1) supporting the plurality of players to acquire at least part of the (2_1)-st supply item and the (2_2)-nd supply item contained in the 2-nd type supply box according to a (2_1)-st mode in which the information on the specific supply box forwarding timing and the 2-nd type supply box forwarding spot is not provided to the plurality of players; or (ii-2) supporting at least part of the plurality of players to acquire at least part of the (2_1)-st supply item and the (2_2)-nd supply item contained in the 2-nd type supply box by providing the information on the specific supply box forwarding timing to at least part of the plurality of players according to a (2_2)-nd mode in which the information on the specific supply box forwarding timing is provided to at least part of the plurality of players; or (ii-3) supporting at least part of the plurality of players to acquire at least part of the (2_1)-st supply item and the (2_2)-nd supply item contained the 2-nd type supply box by providing the information on the 2-nd type supply box forwarding spot to at least part of the plurality of players according to (2_3)-rd mode in which the information on the 2-nd type supply box forwarding spot is provided to at least part of the plurality of players; or (ii-4) supporting at least part of the plurality of players to acquire at least part of the (2_1)-st supply item and the (2_2)-nd supply item contained the 2-nd type supply box by providing information on the specific supply box forwarding timing and the 2-nd type supply box forwarding spot to at least part of the plurality of players according to (2_4)-th mode in which the information on the specific supply box forwarding timing and the 2-nd type supply box forwarding spot is provided to at least part of the plurality of players.

As one example, there is provided a server, wherein, at the process of (II), the processor performs at least part of (i) a process of (i-1) providing at least part of the information on the specific supply box forwarding timing and the 1-st type supply box forwarding spot to at least part of the 1-st player according to any one of the (1_2)-nd mode to the (1_4)-th mode, (i-2) supporting at least part of the 1-st player to display at least part of the information on the specific supply box forwarding timing and the 1-st type supply box forwarding spot through at least part of a 1-st display area for displaying azimuth information, a 2-nd display area for displaying field information, a 3-rd display area for displaying map information and a 4-th display area for displaying visual information, and thus (i-3) supporting at least part of the 1-st player to acquire at least part of the (1_1)-st supply item and the (1_2)-nd supply item contained the 1-st type supply box; and (ii) a process of (ii-1) providing at least part of the information on the specific supply box forwarding timing and the 2-nd type supply box forwarding spot to at least part of the plurality of players according to any one of the (2_2)-nd mode to the (2_4)-th mode, (ii-2) supporting at least part of the plurality of players to display at least part of information on the specific supply box forwarding timing and the 2-nd type supply box forwarding spot through at least part of the 1-st display area, the 2-nd display area, the 3-rd display area and the 4-th display area, and thus (ii-3) supporting at least part of the plurality of players to acquire at least part of the (2_1)-st supply item and the (2_2)-nd supply item contained the 2-nd type supply box.

As one example, there is provided a server, wherein, at the process of (I), on condition that metadata on at least part of a 1-st weight applied to the elapsed time information, a 2-nd weight applied to the player battle power information, a 3-rd weight applied to the area phase information, a 4-th weight applied to the cardinal number of the surviving players and a 5-th weight applied to the possessed item of the surviving players are managed, the server acquires weighted specific game-progression degree by applying at least part of the 1-st weight to the 5-th weight to at least part of specific elapsed time information, specific player battle power information, specific area phase information, specific cardinal number of the surviving players and a specific possessed item of a specific surviving player, and confirms the specific supply box forwarding timing candidates and specific timing probabilities corresponding thereto, wherein the specific supply box forwarding timing candidates match with the weighted specific game-progression degree.

As one example, there is provided a server, wherein, at the process of (I), the processor determines a specific factor whose rate of change in a specific time section is more than or equal to a threshold rate of change among total factors comprised of the player battle power information, the area phase information, the cardinal number of the surviving players and the possessed item of the surviving players, wherein the specific time section corresponds to a specific timing when the specific game-progression degree is acquired among a predetermined plurality of time sections, and the server sets a specific weight corresponding to the specific factor to be greater than other weights corresponding to other factors, wherein said other factors are factors excluding the specific factor among the total factors.

As one example, there is provided a server, wherein, at the process of (I), the game-progression degree is calculated by the progress calculating function having arguments of at least part of (i) the elapsed time information, (ii) the player battle power information, (iii) the area phase information, (iv) the cardinal number of the surviving players, (v) the possessed item of the surviving players, (vi) location distribution information of the supply box previously forwarded in the field in the battle royale game and (vii) location distribution information of the surviving players, and in response to determining that the specific game-progression degree acquired by the progress calculating function in real-time in the 2-nd state satisfies the preset condition, the game server confirming the specific supply box forwarding timing candidates and the specific timing probabilities corresponding thereto.

As one example, there is provided a server, wherein, at the process of (II), the processor (i) determines a 1-st surviving player group to an n-th surviving player group by further referring to at least part of class information on a class applied to a specific surviving player and a specific possessed item of the specific surviving player, and (ii) forwards each of a 1-st matching supply box to an n-th matching supply box matching to each of the 1-st surviving player group to the n-th surviving player group to each of a 1-st supply box forwarding spot to an n-th supply box forwarding spot determined based on locations of each of the 1-st surviving player group to the n-th surviving player group at each of a 1-st specific supply box forwarding timing to an n-th specific supply box forwarding timing, wherein each of the 1-st supply box forwarding spot to the n-th supply box forwarding spot is calculated by each of a predetermined (2_1)-st function to a predetermined (2_n)-th function, wherein the predetermined (2_1)-st function has arguments of at least part of the area metadata, playing locations of at least part of the 1-st surviving player group on a 1-st map and a 1-st designated location by at least part of the 1-st surviving player group and the predetermined (2_n)-th function has arguments of at least part of the area metadata, playing locations of at least part of the n-th surviving player group on an n-th map and an n-th designated location by at least part of the n-th surviving player group, and wherein each of the 1-st specific supply box forwarding timing to the n-th specific supply box forwarding timing is calculated by each of a predetermined (1_1)-st function to a predetermined (1_n)-th function, wherein the predetermined (1_1)-st function has arguments of a 1-st specific supply box forwarding timing candidates and 1-st specific timing probabilities corresponding thereto and the predetermined (1_2)-nd function has arguments of an n-th specific supply forwarding timing candidates and n-th specific timing probabilities corresponding thereto, and (iii) provides at least part of information on the 1-st supply box forwarding spot to the n-th supply box forwarding spot and the 1-st specific supply box forwarding timing and the n-th specific supply box forwarding timing to at least part of the 1-st surviving player group to the n-th surviving player group, thereby supporting at least part of the 1-st surviving player group to the n-th surviving player group to acquire the supply item.

As one example, there is provided a server, wherein, at the process of (II), the processor forwards the supply box to the supply box forwarding spot at the specific supply box forwarding timing, wherein (i) a first item probability that a class synergy item among the supply items is contained in the supply box in case a ratio of at least one specific factor among total factors comprised of specific elapsed time information, specific player battle power information, specific area phase information, specific cardinal number of surviving players and a specific possessed item of a specific surviving player acquired in real-time is more than a specific threshold is greater than (ii) a second item probability that the class synergy item is contained in the supply box in case the ratio of the specific factor among the total factor is less than the threshold, wherein the specific threshold is determined corresponding to the specific supply box forwarding timing, and wherein the class synergy item is an item of which a performance is improved when used by a k-th specific surviving player to whom a k-th class is applied among classes applied to the surviving players, and is determined based on class information on the class applied to the specific surviving player and information on the specific possessed item of the specific surviving player.

### BRIEF DESCRIPTION OF THE DRAWINGS

The accompanying drawings used to explain example embodiments of the present disclosure are only part of example embodiments of the present disclosure and other drawings can be obtained based on the drawings by those skilled in the art of the present disclosure without inventive work.

FIG. 1 is a drawing schematically illustrating a server for providing a battle royale game which forwards a supply box in accordance with one example embodiment of the present disclosure.

FIG. 2 is a drawing for explaining a process for providing the battle royale game which forwards the supply box in accordance with one example embodiment of the present disclosure.

FIG. 3 is a drawing for explaining a method for determining a supply box forwarding spot in accordance with one example embodiment of the present disclosure.

FIG. 4 is a drawing for explaining a method for providing information on the supply box forwarding spot to at least part of players in accordance with one example embodiment of the present disclosure.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components or steps. Other objects, benefits and features of the present disclosure will be revealed to one skilled in the art, partially from the specification and partially from the implementation of the present disclosure. The following examples and drawings will be provided as examples but they are not intended to limit the present disclosure.

Furthermore, the present invention includes all possible combinations of embodiments indicated in the present disclosure. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

The headings and abstract of the present disclosure provided herein are for convenience only and do not limit or interpret the scope or meaning of the embodiments.

To allow those skilled in the art to carry out the present disclosure easily, the example embodiments of the present disclosure will be explained by referring to attached diagrams in detail as shown below.

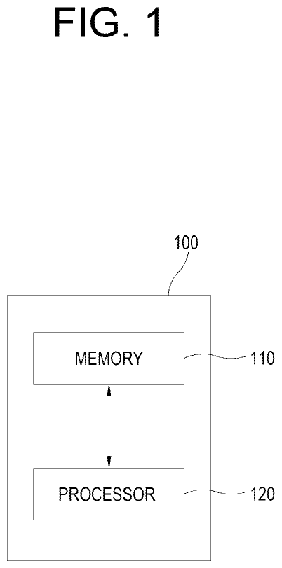

FIG. 1 is a drawing schematically illustrating a server 100 in accordance with one example embodiment of the present disclosure, and the server 100 may include a memory 110 for storing instructions to provide a battle royale game which forwards a supply box, and a processor 120 for providing the battle royale game which forwards the supply box according to the instructions in the memory 110.

Specifically, the server 100 may achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

The processor of the computing device may include hardware configuration of MPU (Micro Processing Unit) or CPU (Central Processing Unit), cache memory, data bus, etc. Additionally, the computing device may further include OS and software configuration of applications that achieve specific purposes.

However, a case in which the computing device includes an integrated processor, integrating a medium, a processor and a memory, for implementing the present disclosure is not excluded.

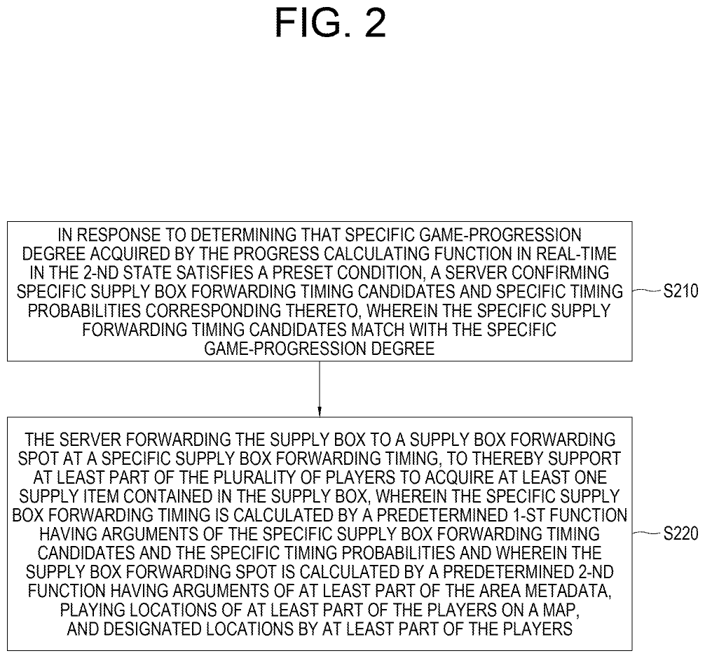

A method for providing the battle royale game which forwards the supply box by using the server 100 configured as explained below is described by referring to FIGS. 2 to 4.

As used in this specification and the appended claims, the singular forms “a,” “an,” and “the” may include plural referents unless the content and context clearly dictates otherwise.

FIG. 2 is a flowchart schematically illustrating a process of the server 100 providing the battle royale game which forwards the supply box in accordance with one example embodiment of the present disclosure.

Herein, the battle royale game is a game in which a plurality of players compete for survival in a specific area. Further, let us assume that a first state of the battle royale game represents a state in which the players log into the battle royale game but do not play the battle royale game and that a second state of the battle royale game represents a state in which the players play the battle royale game.

Briefly explaining the entire flow according to one example embodiment of the present invention by referring to FIG. 2, in response to determining that a specific game-progression degree acquired by a progress calculating function in real-time in the 2-nd state satisfies a preset condition, the server 100 retrieves specific supply box forwarding timing candidates and specific timing probabilities corresponding thereto which match with the specific game-progression degree at a step of S210. Then, the server 100 forwards the supply box to a supply box forwarding spot at a specific supply box forwarding timing, to thereby support at least part of the plurality of players to acquire at least one supply item contained in the supply box. Herein, the specific supply box forwarding timing is calculated by a predetermined 1-st function having arguments of the specific supply box forwarding timing candidates and the specific timing probabilities. Further, the supply box forwarding spot is calculated by a predetermined 2-nd function having arguments of at least part of the area metadata, playing locations of at least part of the players on a map, and designated locations selected by at least part of the players at a step of S220.

Hereinafter, it will be explained in detail on the processes of providing the battle royale game which allows the server 100 to forward the supply box.

Firstly, each of supply box forwarding timing candidates and is corresponding timing probabilities may be set and managed for each of game-progression degrees.

Herein, each of the game-progression degrees may be calculated by using the progress calculating function having arguments of at least part of (i) elapsed time information which represents a time elapsed after the battle royale game enters the 2-nd state, (ii) player battle power information which represents a battle power of at least part of the plurality of players, (iii) area phase information which represents a state of a safe area and a dangerous area being changed according to area metadata, (iv) a cardinal number of surviving players among the plurality of players and (v) possessed item of the surviving players.

As one example, when it is assumed that two minutes elapsed after entering into the 2-nd state and that the phase of a safe area and a dangerous area is the 1-st phase, the game-progression degree calculated by using the progress calculating function having arguments of at least part of elapsed time information, i.e., two minutes, and area phase information, i.e., the 1-st phase, may be game-progression degree satisfying a triggering point for entering the 1-st stage. Herein, the term “stage” is named for convenience based on the turn in which the supply box is forwarded.

As another example, when it is assumed that 22 minutes elapsed after entering into the 2-nd state and that the phase of the safe area and that dangerous area is the 5-th phase, the game-progression degree calculated by using the progress calculating function having arguments of at least part of the elapsed time information, i.e., twenty two minutes, and the area phase information, i.e., the 5-th phase, may be game-progression degree satisfying a triggering point for entering the 9-th stage.

In addition, each of the supply box forwarding timing candidates and its corresponding timing probabilities may be set for each of the game-progression degrees.

As one example, the supply box forwarding timing candidates corresponding to the game-progression degree satisfying a triggering point for entering the 1-st stage may be set as each of times after 20 seconds, after 40 seconds, after 1 minute, after 1 minute and 20 seconds and after 1 minute and 40 seconds from the timing satisfying the triggering point for entering the 1-st stage, and the timing probabilities corresponding thereto may be set as 0.15, 0.2, 0.4, 0.2 and 0.05. As the case may be, the supply box forwarding timing candidates and their corresponding timing probabilities may be determined in real-time. That is, such supply box forwarding timing candidates and their corresponding timing probabilities may be stored and managed in a database as predetermined values, but they are not limited thereto, and depending on the case, on condition that a first reference range of the supply box forwarding timing candidates and a second reference range of the timing probabilities have been stored, the supply box forwarding timing candidates are determined in real-time within the first reference range and the timing probabilities are determined in real-time within the second reference range in the 2-nd state. For reference, it shall be explained on the triggering point later.

As another example, the supply box forwarding timing candidates corresponding to the game-progression degree satisfying the triggering point for entering the 1-st stage may be set as each of times before 1 minute, before 30 seconds, at 0 second, after 30 seconds, after 1 minute from the timing predicted to satisfy the triggering point for entering the 1-st stage, and the timing probabilities corresponding thereto may be set as 0, 0, 1, 0 and 0. As the case may be, the supply box forwarding timing candidates and their corresponding timing probabilities may be determined in real-time. For reference, as in the example above, all probabilities may also be set such that they are not 0.

As still another example, the supply box forwarding timing candidates corresponding to the game-progression degree satisfying the triggering point for entering the 9-th stage may be set as each of times after 30 seconds, after 1 minute, after 1 minute and 30 seconds, after 2 minutes, after 2 minute and 30 seconds from the timing predicted to satisfy the triggering point for entering the 9-th stage, and the timing probabilities corresponding thereto may be set as 0, 1, 0, 0 and 0. As the case may be, the supply box forwarding timing candidates and their corresponding timing probabilities may be determined in real-time.

As still another example, the supply box forwarding timing candidates corresponding to the game-progression degree satisfying the triggering point for entering the 9-th stage may be set as each of times before 40 seconds, before 20 seconds, at 0 second, after 20 seconds, after 40 seconds from the timing predicted to satisfy the triggering point for entering the 9-th stage, and the timing probabilities corresponding thereto may be set as 0.15, 0.25, 0.3, 0.2 and 0.1. As the case may be, the supply box forwarding timing candidates and their corresponding timing probabilities may be determined in real-time.

Accordingly, on condition that each of the supply box forwarding timing candidates and its corresponding timing probabilities are set and managed for each of the game-progression degrees, the server 100 may determine whether the specific game-progression degree acquired by the progress calculating function in real-time in the 2-nd state satisfies the preset condition.

As one example, the server 100 may determine whether at least part (i.e., any combination) of each of factors of (i) the elapsed time information, (ii) the player battle power information, (iii) the area phase information, (iv) the cardinal number of the surviving players and (v) the possessed item of the surviving players satisfies the triggering point.

For example, on condition that a triggering point for player battle power average information has been set as 1000, and a triggering point for the area phase information has been set as the 1-st phase, and a triggering point for the cardinal number of the surviving players has been set as 80 players, in response to detecting that a part of the factors corresponding to the specific game-progression degree acquired by the progress calculating function in real-time satisfies their corresponding triggering points, e.g., in response to detecting that the player battle power average information is 1,200, the area phase information is the 1-st phase, the cardinal number of the surviving players is 75 players, the server 100 may determine that the specific game-progression degree satisfies the preset condition, and thus allow at least one first supply box to be forwarded. For reference, such factors do not need to satisfy the preset condition all at once, and depending on the case, if a predetermined ratio of the factors or a predetermined cardinal number of the factors is satisfied, it may be regarded as satisfying the preset condition.

As another example, on condition that the triggering point for the combination of the player battle power average information, the area phase information and the cardinal number of surviving players has been set as 2000, in response to detecting that a part of the factors corresponding to the specific game-progression degree acquired by the progress calculating function in real-time satisfies their corresponding triggering points, e.g. in response to detecting that the combination of the player battle power average information, the area phase information and the cardinal number of surviving players is 2,500, the server may determine that the specific game-progression degree satisfies the preset condition, and thus allow at least one first supply box to be forwarded.

As still another example, on condition that the triggering point for the player battle power average information has been set as 1,500, and the triggering point for the area phase information has been set as the 2-nd phase, and the triggering point for the cardinal number of the surviving players has been set as 50 players, in response to detecting that a part of the factors corresponding to the specific game-progression degree acquired by the progress calculating function in real-time does not yet satisfy their corresponding triggering points, e.g., in response to detecting that the player battle power average information is 1,450, the area phase information is the 1-st phase, the cardinal number of the surviving players is 55 players, the server 100 may determine that the specific game-progression degree does not yet satisfy the triggering point, but it will satisfy the triggering point in near time, and thus may predict the timing that will satisfy the triggering point by referring to the change rate and change ratio, etc. of each of the factors, to allow at least one first supply box to be forwarded.

In addition, in response to detecting that the preset condition is satisfied as above, the server 100 may retrieve the specific supply box forwarding timing candidates and their corresponding specific timing probabilities matching with the specific game-progression degree. As explained above, the term “probabilities” here may refer to accurate values stored in the database, but may also be a predetermined range.

In addition, the server 100 may forward each of the supply boxes to each of its corresponding supply box forwarding spots at each of its corresponding specific supply box forwarding timings. Herein each of the specific supply box forwarding timings is calculated by the predetermined 1-st function having arguments of the specific supply box forwarding timing candidates and the specific timing probabilities and each of the supply box forwarding spots is calculated by the predetermined 2-nd function having arguments of at least part of the area metadata, playing locations of at least part of the players on a map, and designated locations selected by at least part of the players.

For example, the manner of determining each of the specific supply box forwarding timings will be explained by referring to the game-progression degree satisfying the triggering point for entering the 1-st stage and the game-progression degree satisfying the triggering point for entering the 9-th stage explained earlier.

As one example, in response to determining that the specific game-progression degree acquired by the progress calculating function in real-time in the 2-nd state is the game-progression degree satisfying the triggering point for entering the 1-st stage, the server 100 may determine a time “after 1 minute from the timing satisfying the triggering point”, corresponding to 0.4 which is the highest probability, as a specific supply box forwarding timing, by the predetermined 1-st function having arguments of (i) the specific supply box forwarding timing candidates (for example, each of times after 20 seconds, after 40 seconds, after 1 minute, after 1 minute and 20 seconds and after 1 minute and 40 seconds from the timing satisfying the triggering point) and (ii) the specific timing probabilities (for example, 0.15, 0.2, 0.4, 0.2 and 0.05) corresponding to the game-progression degree satisfying the triggering point for entering the 1-st stage.

As another example, unlike the above, the server 100 may determine a time “after 1 minute 40 seconds from the timing satisfying the triggering point”, corresponding to 0.05 which is the lowest probability, as the specific supply box forwarding timing.

As another example, in response to determining that the specific game-progression degree acquired by the progress calculating function in real-time in the 2-nd state is the game-progression degree satisfying the triggering point for entering the 9-th stage, the server 100 may determine “the timing predicted to satisfy the triggering point” as the specific supply box forwarding timing by using the predetermined 1-st function having arguments of (i) the specific supply box forwarding timing candidates (for example, each of times before 40 seconds, before 20 seconds, at 0 second, after 20 seconds, after 40 seconds from the timing predicted to satisfy the triggering point) and (ii) the specific timing probabilities (for example, 0.15, 0.25, 0.3, 0.2 and 0.1) corresponding to the game-progression degree satisfying the triggering point for entering the 9-th stage.

Meanwhile, the manner of determining the supply box forwarding spot will be explained as below.

As one example, the server 100 may determine an average value of the at least part of locations of 90 surviving players on the map as the supply box forwarding spot through the predetermined 2-nd function having arguments of the locations of the 90 surviving players among 100 players participating in the same battle royale game.

As another example, the server 100 may determine an average value of at least part of designated locations of 20 surviving players as the supply box forwarding spot through the predetermined 2-nd function having arguments of the designated locations of the 20 surviving players among the 100 players participating in the same battle royale game.

As still another example, the server 100 may determine each of designated locations of 10 surviving players as the supply box forwarding spot through the predetermined 2-nd function having arguments of the designated locations of the 10 surviving players among the 100 players participating in the same battle royale game.

It was explained as to the manner of determining the specific supply box forwarding timing and the supply box forwarding spot, and hereinafter, various examples of providing the battle royale game capable of forwarding supply boxes are explained.

As one example, on condition that at least part of a 1-st weight applied to the elapsed time information, a 2-nd weight applied to the player battle power information, a 3-rd weight applied to the area phase information, a 4-th weight applied to the cardinal number of the surviving players and a 5-th weight applied to the possessed item of the surviving players have been set, the server 100 may acquire a weighted specific game-progression degree by applying at least part of the 1-st weight to the 5-th weight respectively to at least part of specific elapsed time information, specific player battle power information, specific area phase information, a specific cardinal number of specific surviving players and specific possessed items of the specific surviving players, and may confirm, i.e., retrieve, the specific supply box forwarding timing candidates and their corresponding specific timing probabilities matching with the weighted specific game-progression degree.

Herein, the server 100 may determine a specific factor whose rate of change within a specific time section is more than or equal to a threshold rate of change among total factors comprised of the player battle power information, the area phase information, the cardinal number of the surviving players and the possessed item of the surviving players, and the server 100 may set a specific weight corresponding to the specific factor to be greater than other weights corresponding to other factors.

For reference, the specific time section may be a time section which corresponds to a specific timing when the specific game-progression degree is acquired among a plurality of time sections. In addition, said other factors may be factors excluding the specific factor among the total factors.

For example, explaining as to the possessed item of the surviving players among the factors corresponding to the game-progression degree, in order prevent the game flow from becoming boring due to surviving players uniformly using the same weapon, a supply box may be forwarded at an appropriate supply box forwarding timing. For example, in line with a situation where 80% or more of the surviving players are in possession of a specific short-distance weapon, the supply box forwarding timing candidates and their corresponding timing probabilities may be set and managed.

On condition that circumstances are managed as above, in response to acquiring information on the possessed items of the surviving players representing that 50% or more of the surviving players are in possession of the specific short-distance weapon, the server 100 may determine the specific game-progression degree through the progress calculating function having arguments of the possessed items of the surviving players, and may confirm, i.e., retrieve, the specific supply box forwarding timing candidates and the specific timing probabilities corresponding to the specific game-progression degree. In addition, since it is confirmed that the situation is not right to forward the supply box, e.g., since it is not a case in which 80% or more of the surviving players are in possession of the specific short-distance weapon, the server 100 will not forward its corresponding supply box.

As another example, in response to acquiring information on the possessed items of the surviving players representing that 85% or more of the surviving players are in possession of the specific short-distance weapon, the server 100 may confirm the specific supply box forwarding timing by referring to the information on the possessed items of the surviving players. In addition, since it is confirmed that the situation is right to forward the supply box, e.g., since it is a case in which 80% or more of the surviving players are in possession of the specific short-distance weapon, the server 100 may forward its corresponding supply box.

Herein, the supply box forwarding timing candidates and the timing probabilities may be further set and managed for at least part of location distribution information of the supply box(es) previously forwarded in the field in the battle royale game and location distribution information of the surviving players.

For example, in case the locations of the surviving players are intensively distributed in a specific region while the supply boxes previously forwarded were forwarded to one or more spots far away from the specific region, even if the timing when a previous supply box forwarded immediately before is within a threshold time section from a current timing (that is, the situation when is not much after the supply box was forwarded), the likelihood of the supply boxes previously forwarded being used by the players is low. In such a case, in order to allow the players to actively use supply items by forwarding a new supply box again, the supply box forwarding timing candidates and the timing probabilities may be further set and managed for at least part of the location distribution information of the supply box previously forwarded in the field in the battle royale game and the location distribution information of the surviving players.

Meanwhile, the server 100 may forward at least part of the 1-st type supply box and the 2-nd type supply box respectively to at least part of the 1-st type supply box forwarding spot and the 2-nd type supply box forwarding spot at their corresponding specific supply box forwarding timings.

Herein, the 1-st type supply box may contain, as the supply item, at least part of the (1_1)-st supply item determined by the 1-st player in the 1-st state and the (1_2)-nd supply item determined by the 1-st player in the 2-nd state, and the 2-nd type supply box may contain at least part of the (2_1)-st supply item determined by the server 100 in the 1-st state and the (2_2)-nd supply item determined by the server 100 in the 2-nd state.

For reference, the supply item contained in the 1-st type supply box may include at least part of the (1_1)-st supply item and the (1_2)-nd supply item, but it is not limited thereto. For example, the supply item contained in the 1-st type supply box may include at least part of the (1_1)-st supply item and the (1_2)-nd supply item, and may further include at least part of a (1_3)-rd supply item determined in the 1-st state and a (1_4)-th supply item determined in the 2-nd state.

In addition, each of the 1-st type supply box forwarding spot and the 2-nd type supply box forwarding spot may be determined by the predetermined 2-nd function having arguments of at least part of the area metadata, the playing locations of at least part of the players on a map, and the designated locations selected by at least part of the players.

Therethrough, the server 100 may support at least one 1-st player among the plurality of players to acquire at least part of a (1_1)-st supply item and a (1_2)-nd supply item contained in the 1-st type supply box, or support at least part of the plurality of players to acquire at least part of a (2_1)-st supply item and a (2_2)-nd supply item contained in the 2-nd type supply box.

Herein, the 1-st type supply box may contain, as the supply item, at least part of a (1_1)-st class synergy item determined by the first player in the 1-st state and a (1_2)-nd class synergy item determined by the first player in the 2-nd state among 1-st class synergy items corresponding to a 1-st class applied to the 1-st player.

Herein, the 1-st class synergy item may be an item of which a performance is improved when used by the 1-st player to whom the 1-st class is applied among one or more classes which are applied to the plurality of players.

As another example, the 2-nd type supply box may contain, as the supply item, at least part of a (2_1)-st item determined by the server in the 1-st state and a (2_2)-nd item determined by the server in the 2-nd state, among items used in the battle royale game, based on at least part of specific elapsed time information, specific player battle power information, specific area phase information, a specific cardinal number of surviving players and a specific possessed item of a specific surviving player.

In addition, the server 100 may not provide information on the specific supply box forwarding timing and the forwarding spot to the player, but, as another example, may provide at least part of the information on the specific supply box forwarding timing and the forwarding spot to the player.

As one example, the server 100 may forward the 1-st type supply box to the 1-st type supply box forwarding spot at the specific supply box forwarding timing, and support at least part of the 1-st player to acquire at least part of the (1_1)-st supply item and the (1_2)-nd supply item contained the 1-st type supply box according to a (1_1)-st mode. Herein, the (1_1)-st mode is a mode in which information on the specific supply box forwarding timing and the 1-st type supply box forwarding spot is not provided to the 1-st player.

As another example, the server 100 may forward the 1-st type supply box to the 1-st type supply box forwarding spot at the specific supply box forwarding timing, and support at least part of the 1-st player to acquire at least part of the (1_1)-st supply item and the (1_2)-nd supply item contained the 1-st type supply box by providing information on the specific supply box forwarding timing to at least part of the 1-st player according to a (1_2)-nd mode.

As still another example, the server 100 may forward the 1-st type supply box to the 1-st type supply box forwarding spot at the specific supply box forwarding timing, and support at least part of the 1-st player to acquire at least part of the (1_1)-st supply item and the (1_2)-nd supply item contained the 1-st type supply box by providing the information on the 1-st type supply box forwarding spot to at least part of the 1-st player according to a (1_3)-rd mode.

As still yet another example, the server 100 may forward the 1-st type supply box to the 1-st type supply box forwarding spot at the specific supply box forwarding timing, and support at least part of the 1-st player to acquire at least part of the (1_1)-st supply item and the (1_2)-nd supply item contained the 1-st type supply box by providing information on the specific supply box forwarding timing and the 1-st type supply box forwarding spot to at least part of the 1-st player according to a (1_4)-th mode.

In addition, similar to the explanation on the 1-st type supply box, the server 100 may forward the 2-nd type supply box to the 2-nd type supply box forwarding spot at the specific supply box forwarding timing, and support the plurality of players to acquire at least part of the (2_1)-st supply item and the (2_2)-nd supply item contained in the 2-nd type supply box according to a (2_1)-st mode. Herein, the (2_1)-st mode is a mode in which the information on the specific supply box forwarding timing and the 2-nd type supply box forwarding spot is not provided to the plurality of players.

As still yet another example, the server 100 may forward the 2-nd type supply box to the 2-nd type supply box forwarding spot at the specific supply box forwarding timing, and support at least part of the plurality of players to acquire at least part of the (2_1)-st supply item and the (2_2)-nd supply item contained in the 2-nd type supply box by providing the information on the specific supply box forwarding timing to at least part of the plurality of players according to a (2_2)-nd mode.

As still yet another example, the server 100 may forward the 2-nd type supply box to the 2-nd type supply box forwarding spot at the specific supply box forwarding timing, and support at least part of the plurality of players to acquire at least part of the (2_1)-st supply item and the (2_2)-nd supply item contained the 2-nd type supply box by providing the information on the 2-nd type supply box forwarding spot to at least part of the plurality of players according to (2_3)-rd mode.

As still yet another example, the server 100 may forward the 2-nd type supply box to the 2-nd type supply box forwarding spot at the specific supply box forwarding timing, and support at least part of the plurality of players to acquire at least part of the (2_1)-st supply item and the (2_2)-nd supply item contained the 2-nd type supply box by providing information on the specific supply box forwarding timing and the 2-nd type supply box forwarding spot to at least part of the plurality of players according to (2_4)-th mode.

Herein, the server 100 may provide at least part of the information on the specific supply box forwarding timing and the 1-st type supply box forwarding spot to at least part of the 1-st player according to any one of the (1_2)-nd mode to the (1_4)-th mode, support at least part of the 1-st player to display at least part of the information on the specific supply box forwarding timing and the 1-st type supply box forwarding spot through at least part of a 1-st display area for displaying azimuth information, a 2-nd display area for displaying field information, a 3-rd display area for displaying map information and a 4-th display area for displaying visual information, and thus support at least part of the 1-st player to acquire at least part of the (1_1)-st supply item and the (1_2)-nd supply item contained the 1-st type supply box.

Similar to the explanation on the 1-st type supply box, the server 100 may provide at least part of the information on the specific supply box forwarding timing and the 2-nd type supply box forwarding spot to at least part of the plurality of players according to any one of the (2_2)-nd mode to the (2_4)-th mode, support at least part of the plurality of players to display at least part of information on the specific supply box forwarding timing and the 2-nd type supply box forwarding spot through at least part of the 1-st display area, the 2-nd display area, the 3-rd display area and the 4-th display area, and thus support at least part of the plurality of players to acquire at least part of the (2_1)-st supply item and the (2_2)-nd supply item contained the 2-nd type supply box.

Meanwhile, the server 100 according to one example of the present invention may determine a 1-st surviving player group to an n-th surviving player group by further referring to at least part of class information on a class applied to a specific surviving player and a specific possessed item of the specific surviving player.

As one example, on condition that a 1-st class is applied to 20 surviving players among 40 specific surviving players, a 2-nd class is applied to 10 surviving players among the 40 specific surviving players, and a 3-rd class is applied to 10 surviving players among the 40 specific surviving players, the server 100 may classify the 40 specific surviving players into one of (i) a 1-st surviving player group which is a group of the 20 surviving players to whom the 1-st class is applied, (ii) a 2-nd surviving player group which is a group of the 10 surviving players to whom the 2-nd class is applied, and (iii) a 3-rd surviving player group which is a group of the 10 surviving players to whom the 3-rd class is applied, by further referring to the class information of the 40 specific surviving players.

As another example, on condition that the 1-st class is applied to 20 surviving players among the 40 specific surviving players, a 2-nd class is applied to 10 surviving players among the 40 specific surviving players, and a 3-rd class is applied to 10 surviving players among the 40 specific surviving players, and that 10 players among the 20 surviving players of the 1-st class are in possession of short-distance attacking weapon, and the remaining 10 players among the 20 surviving players of the 1-st class are in possession of long-distance attacking weapon, 6 players among the 10 surviving players of the 2-nd class are in possession of the short-distance attacking weapon, and the remaining 4 players among the 10 surviving players of the 2-nd class are in possession of the long-distance attacking weapon, and 3 players among the 10 surviving players of the 3-rd class are in possession of the short-distance attacking weapon, and the remaining 7 players among the 10 surviving players of the 3-rd class are in possession of the long-distance attacking weapon, the server 100 may classify the 40 specific surviving players into one of (i) a 1-st surviving player group which is a group of the 10 surviving players to whom the 1-st class is applied and are in possession of the short-distance attacking weapon, (ii) a 2-nd surviving player group which is a group of the 10 surviving players to whom the 2-nd class is applied and are in possession of the long-distance attacking weapon, (iii) a 3-rd surviving player group which is a group of the 6 surviving players to whom the 2-nd class is applied and are in possession of the short-distance attacking weapon, (iv) a 4-th surviving player group which is a group of 4 surviving players to whom the 2-nd class is applied and are in possession of the long-distance attacking weapon, (v) a 5-th surviving player group which is a group of the 3 surviving players to whom the 3-rd class is applied and are in possession of the short-distance attacking weapon, and (vi) a 6-th surviving player group which is a group of the 7 surviving players to whom the 3-rd class is applied and are in possession of the long-distance attacking weapon, by further referring to the class information of the 40 specific surviving players and the specific possessed items of the specific surviving players.

In addition, the server 100 may forward each of a 1-st matching supply box to an n-th matching supply box matching to each of the 1-st surviving player group to the n-th surviving player group to each of a 1-st supply box forwarding spot to an n-th supply box forwarding spot determined based on each of locations of each of the 1-st surviving player group to the n-th surviving player group at each of a 1-st specific supply box forwarding timing to an n-th specific supply box forwarding timing.

Herein, each of the 1-st supply box forwarding spot to the n-th supply box forwarding spot is calculated by each of a predetermined (2_1)-st function to a predetermined (2_n)-th function, wherein the predetermined (2_1)-st function has arguments of at least part of the area metadata, playing locations of at least part of the 1-st surviving player group on a 1-st map and 1-st designated locations selected by at least part of the 1-st surviving player group and the predetermined (2_n)-th function has arguments of at least part of the area metadata, playing locations of at least part of the n-th surviving player group on an n-th map and n-th designated locations selected by at least part of the n-th surviving player group.

For example, a k-th supply box forwarding spot may be defined by a predetermined (2_k)-th function having arguments of at least part of the area metadata, playing locations of at least part of a k-th surviving player group on a k-th map and k-th designated locations selected by at least part of the k-th surviving player group. Herein, the k-th supply box forwarding spot may be defined by a predetermined (2_k)-th function having further argument of information on levels in a game imparted to k-th surviving players who belong to the k-th surviving player group.

For example, when (i) higher levels are imparted to a (k_1)-st surviving player to a (k_5)-th surviving player among the k-th surviving player group, i.e., a (k_1)-st surviving player to a (k_10)-th surviving player, and (ii) lower levels are imparted to a (k_6)-th surviving player to a (k_10)-th surviving player among the k-th surviving player group, the k-th supply box forwarding spot may be defined as a location near locations of the (k_1)-st surviving player to the (k_5)-st surviving player on the map, or the k-th supply box forwarding spot may be defined as a location near the designated locations of the (k_1)-st surviving player to the (k_5)-st surviving player.

In addition, each of the 1-st specific supply box forwarding timing to the n-th specific supply box forwarding timing is calculated by each of a predetermined (1_1)-st function to a predetermined (1_n)-th function. Herein the predetermined (1_1)-st function has arguments of 1-st specific supply box forwarding timing candidates and 1-st specific timing probabilities corresponding thereto and the predetermined (1_n)-th function has arguments of an n-th specific supply forwarding timing candidates and n-th specific timing probabilities corresponding thereto.

As an example, the server 100 may determine each of locations of each of the 1-st surviving player group to the n-th surviving player group in a manner of determining an average value of coordinates of corresponding players belonging to each of surviving player groups, and may forward the supply box to the supply box forwarding spot determined based on each of the locations of each of the 1-st surviving player group to the n-th surviving player group at a specific supply box forwarding timing.

In addition, the server 100 may provide at least part of information on the supply box forwarding spot and the specific supply box forwarding timing to at least part of the 1-st surviving player group to the n-th surviving player group, thereby supporting at least part of the 1-st surviving player group to the n-th surviving player group to acquire the supply item.

In addition, the server 100 according to one embodiment of the present invention may forward the supply box to the supply box forwarding spot at the specific supply box forwarding timing. Herein (i) a first item probability that a class synergy item among the supply items is contained in the supply box in case a ratio of at least one specific factor among total factors comprised of specific elapsed time information, specific player battle power information, specific area phase information, specific cardinal number of surviving players and a specific possessed item of a specific surviving player acquired in real-time is equal to or greater than a specific threshold is determined as greater than (ii) a second item probability that the class synergy item is contained in the supply box in case the ratio of the specific factor among the total factor is less than the threshold.

Herein, the specific threshold is determined as corresponding to the specific supply box forwarding timing.

For example, the specific threshold corresponding to the first supply box forwarding timing and the specific threshold corresponding to the second supply box forwarding timing may be different from each other, but they are not limited thereto, and may be identical to each other.

In addition, the class synergy item is an item of which a performance is improved when used by a k-th specific surviving player to whom a k-th class is applied among classes applied to the surviving players, and may be determined based on class information on the class applied to the specific surviving player and information on the specific possessed item of the specific surviving player.

For reference, a first item probability that a class synergy item among the supply items is contained in the supply box, in case a ratio of at least one specific factor among total factors comprised of specific elapsed time information, specific player battle power information, specific area phase information, specific cardinal number of surviving players and a specific possessed item of a specific surviving player acquired in real-time is equal to or greater than a specific threshold, may be set to have a fixed probability, but it is not limited thereto.

As one example, proportional to the extent of a ratio of at least one specific factor among the total factors being greater than the specific threshold, the first item probability that the classy synergy item among the supply items is contained in the supply box may become greater.

For example, in case the specific threshold is set to 3/5, (i) where the number of specific factors satisfying the specific supply box forwarding timing among 5 total factors is 2, since the ratio of the specific factors among the total factors is less than the specific threshold, the first probability that the class synergy item is contained in the supply box may be set to 0%, and (ii) where the number of the specific factors satisfying the specific supply box forwarding timing among the 5 total factors is 3, since the ratio of the specific factors among the total factors is 3/5 and is equal to the specific threshold, the first probability that the class synergy item is contained in the supply box may be set to 70%, and (iii) where the number of the specific factors satisfying the specific supply box forwarding timing among the 5 total factors is 5, since the ratio of the specific factors among the total factors is 5/5 and is much more than the specific threshold, the first probability that the class synergy item is contained in the supply box may be set to 90%.

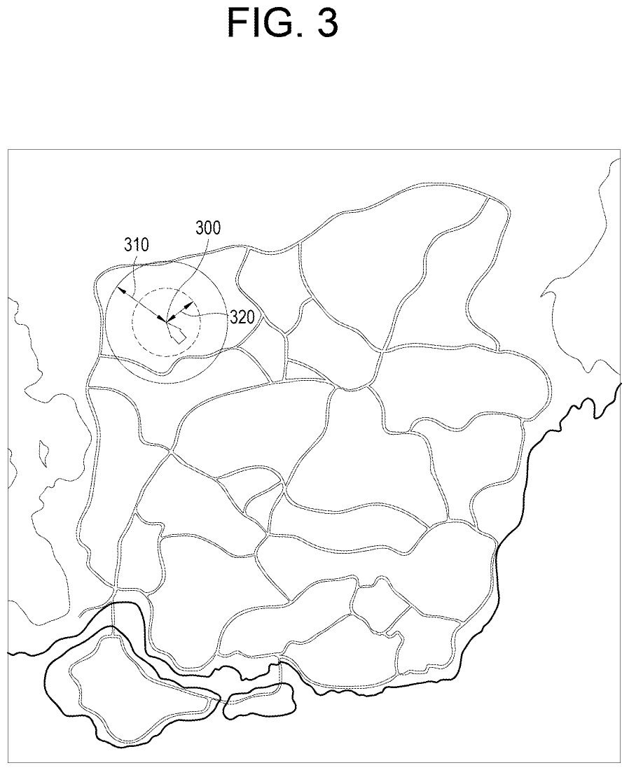

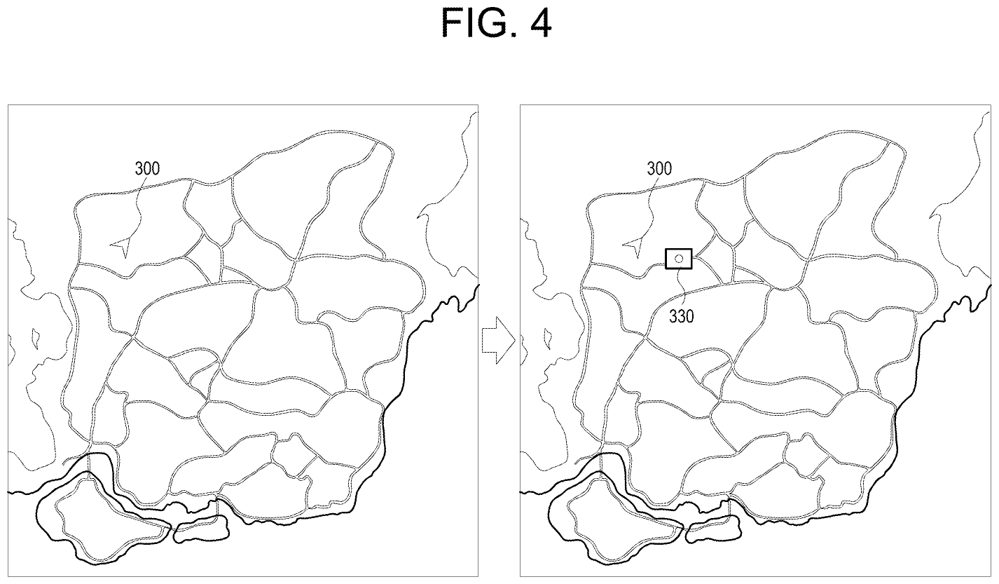

By referring to FIG. 3 and FIG. 4, various embodiments according to the present invention are explained below.

FIG. 3 is a drawing for explaining a method for determining a forwarding spot of a supply box by the server in accordance with one example embodiment of the present disclosure.

As one example, the server 100 may determine the supply box forwarding spot by a predetermined 2-nd function having arguments of at least part of the area metadata, playing locations of at least part of the players on a map, and designated locations by at least part of the players.

Herein, the playing locations of at least part of the players on the map may include the playing locations on the map at the specific supply box forwarding timing when the server is about to forward the supply box or at a timing before a predetermined time from the specific supply box forwarding timing.

For example, the server 100 may determine the coordinates determined in the area within a predetermined distance 310, 320 from the playing locations of at least part of the players on the map as the supply box forwarding spot. Herein, the supply box forwarding spot may mean the coordinates of the internal area of the circle represented by the predetermined distance 310, 320 with the coordinates calculated by referring to the playing locations of at least part of the players on a map 300 as the center, but the form of the area represented by the predetermined distance 310, 320 shall not be limited to a circle.

Meanwhile, the server 100 may control or support at least part of plurality of players to control the predetermined distance 310, 320 by referring to at least one of the game money used by at least part of the players, items possessed by at least part of the players, and a predetermined qualification obtained by at least part of the players clearing a predetermined mission in the battle royale game.

For example, if the predetermined distance 310, 320 is classified as a 1-st predetermined distance 310 and a 2-nd predetermined distance 320 according to its length, if, at first, a supply box is forwarded to the internal area of the circle with the radius of the 1-st predetermined distance 310, then in case at least part of the players pay the game money or use the item, a specific supply box may be forwarded to the internal area of the circle with the radius of the 2-nd predetermined distance 320.

As another example, the server 100 may set the probability of the specific supply box being forwarded to be greater as the distance increases from the playing locations of at least part of the players on the map.

Meanwhile, FIG. 4 is an exemplary drawing for explaining a process for informing information on the supply box forwarding spot to users by the server in accordance with one example embodiment of the present disclosure.

As one example, the information on the supply box forwarding spot 330 may be displayed on a minimap of the battlefield (not shown) in which the characters of the users are playing or a predetermined map as shown in FIG. 4.

Through the configuration above, the server 100 according to one example embodiment of the present invention may determine the forwarding timing and the forwarding spot of the supply box by referring to the information on various situations in the game, and may support the users in the battle royale game to continuously have interests in the battle royale game.

The present disclosure has an effect of determining a forwarding timing and a forwarding spot of a supply box in a battle royale game by referring to information on various situations in the battle royale game.

The present disclosure has another effect of allowing players participating in the battle royale game to continuously have interests in the battle royale game.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case. The hardware device may include a processor such as a CPU or a GPU, combined with a memory device such as ROM or RAM to store the program commands, configured to execute the commands stored in the memory, and a communication part which can exchange signals with external devices. In addition, the hardware device may include a keyboard, a mouse, and any other external input device to receive commands prepared by developers.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for providing a battle royale game which forwards a supply box, wherein the battle royale game is a game in which a plurality of players compete for survival in a specific area, wherein a first state of the battle royale game represents a state in which the players log into the battle royale game but do not play the battle royale game and wherein a second state of the battle royale game represents a state in which the players play the battle royale game, comprising steps of:
(a) on condition that each of supply box forwarding timing candidates for each of game-progression degrees and each of timing probabilities corresponding thereto are set and managed, each of the game-progression degrees is calculated by using a progress calculating function having arguments of at least part of (i) elapsed time information which represents a time elapsed after the battle royale game enters the 2-nd state, (ii) player battle power information which represents a battle power of at least part of the plurality of players, (iii) area phase information which represents a state of a safe area and a dangerous area being changed according to area metadata, (iv) a cardinal number of surviving players among the plurality of players and (v) possessed item of the surviving players, in response to determining that specific game-progression degree acquired by the progress calculating function in real-time in the 2-nd state satisfies a preset condition, a server confirming specific supply box forwarding timing candidates and specific timing probabilities corresponding thereto, wherein the specific supply box forwarding timing candidates match with the specific game-progression degree; and
(b) the server forwarding the supply box to a supply box forwarding spot at a specific supply box forwarding timing, to thereby support at least part of the plurality of players to acquire at least one supply item contained in the supply box, wherein the specific supply box forwarding timing is calculated by a predetermined 1-st function having arguments of the specific supply box forwarding timing candidates and the specific timing probabilities and wherein the supply box forwarding spot is calculated by a predetermined 2-nd function having arguments of at least part of the area metadata, playing locations of at least part of the players on a map, and designated locations by at least part of the players.

2. The method of claim 1, wherein, at the step of (b), the server forwards at least part of a 1-st type supply box and a 2-nd type supply box to at least part of a 1-st type supply box forwarding spot and a 2-nd type supply box forwarding spot at the specific supply box forwarding timing, to thereby support at least one 1-st player among the plurality of players to acquire at least part of a (1_1)-st supply item and a (1_2)-nd supply item contained in the 1-st type supply box, or support at least part of the plurality of players to acquire at least part of a (2_1)-st supply item and a (2_2)-nd supply item contained in the 2-nd type supply box, wherein the 1-st type supply box contains at least part of the (1_1)-st supply item determined by the 1-st player in the 1-st state and the (1_2)-nd supply item determined by the 1-st player in the 2-nd state, and wherein the 2-nd type supply box contains at least part of the (2_1)-st supply item determined by the server in the 1-st state and the (2_2)-nd supply item determined by the server in the 2-nd state, and wherein each of the 1-st type supply box and the 2-nd type supply box is forwarded to each of the 1-st type supply box forwarding spot and the 2-nd type supply box forwarding spot defined as the supply box forwarding spot by the predetermined 2-nd function having arguments of at least part of the area metadata, the playing locations of at least part of the players on the map and the designated locations by at least part of the players.

3. The method of claim 2, wherein the 1-st type supply box contains, as the supply item, at least part of a (1_1)-st class synergy item determined by the first player in the 1-st state and a (1_2)-nd class synergy item determined by the first player in the 2-nd state among 1-st class synergy items corresponding to a 1-st class applied to the 1-st player, wherein the 1-st class synergy item is an item of which a performance is improved when used by the 1-st player to whom the 1-st class applies among at least one class which applies to the plurality of players, and
wherein the 2-nd type supply box contains at least part of a (2_1)-st item determined by the server in the 1-st state and a (2_2)-nd item determined by the server in the 2-nd state, among items used in the battle royale game, based on at least part of specific elapsed time information, specific player battle power information, specific area phase information, a specific cardinal number of surviving players and a specific possessed item of a specific surviving player.

4. The method of claim 2, wherein, at the step of (b), the server performs at least part of (i) a process of forwarding the 1-st type supply box to the 1-st type supply box forwarding spot at the specific supply box forwarding timing, and (i-1) supporting at least part of the 1-st player to acquire at least part of the (1_1)-st supply item and the (1_2)-nd supply item contained the 1-st type supply box according to a (1_1)-st mode in which information on the specific supply box forwarding timing and the 1-st type supply box forwarding spot is not provided to the 1-st player; or (i-2) supporting at least part of the 1-st player to acquire at least part of the (1_1)-st supply item and the (1_2)-nd supply item contained the 1-st type supply box by providing information on the specific supply box forwarding timing to at least part of the 1-st player according to a (1_2)-nd mode in which the information on the specific supply box forwarding timing is provided to at least part of the 1-st player; or (i-3) supporting at least part of the 1-st player to acquire at least part of the (1_1)-st supply item and the (1_2)-nd supply item contained the 1-st type supply box by providing the information on the 1-st type supply box forwarding spot to at least part of the 1-st player according to a (1_3)-rd mode in which the information on the 1-st type supply box forwarding spot is provided to at least part of the 1-st player; or (i-4) supporting at least part of the 1-st player to acquire at least part of the (1_1)-st supply item and the (1_2)-nd supply item contained the 1-st type supply box by providing information on the specific supply box forwarding timing and the 1-st type supply box forwarding spot to at least part of the 1-st player according to a (1_4)-th mode in which the information on the specific supply box forwarding timing and the 1-st type supply box forwarding spot is provided to at least part of the 1-st player; and (ii) a process of forwarding the 2-nd type supply box to the 2-nd type supply box forwarding spot at the specific supply box forwarding timing, and (ii-1) supporting the plurality of players to acquire at least part of the (2_1)-st supply item and the (2_2)-nd supply item contained in the 2-nd type supply box according to a (2_1)-st mode in which the information on the specific supply box forwarding timing and the 2-nd type supply box forwarding spot is not provided to the plurality of players; or (ii-2) supporting at least part of the plurality of players to acquire at least part of the (2_1)-st supply item and the (2_2)-nd supply item contained in the 2-nd type supply box by providing the information on the specific supply box forwarding timing to at least part of the plurality of players according to a (2_2)-nd mode in which the information on the specific supply box forwarding timing is provided to at least part of the plurality of players; or (ii-3) supporting at least part of the plurality of players to acquire at least part of the (2_1)-st supply item and the (2_2)-nd supply item contained the 2-nd type supply box by providing the information on the 2-nd type supply box forwarding spot to at least part of the plurality of players according to (2_3)-rd mode in which the information on the 2-nd type supply box forwarding spot is provided to at least part of the plurality of players; or (ii-4) supporting at least part of the plurality of players to acquire at least part of the (2_1)-st supply item and the (2_2)-nd supply item contained the 2-nd type supply box by providing information on the specific supply box forwarding timing and the 2-nd type supply box forwarding spot to at least part of the plurality of players according to (2_4)-th mode in which the information on the specific supply box forwarding timing and the 2-nd type supply box forwarding spot is provided to at least part of the plurality of players.

5. The method of claim 4, wherein, at the step of (b), the server performs at least part of (i) a process of (i-1) providing at least part of the information on the specific supply box forwarding timing and the 1-st type supply box forwarding spot to at least part of the 1-st player according to any one of the (1_2)-nd mode to the (1_4)-th mode, (i-2) supporting at least part of the 1-st player to display at least part of the information on the specific supply box forwarding timing and the 1-st type supply box forwarding spot through at least part of a 1-st display area for displaying azimuth information, a 2-nd display area for displaying field information, a 3-rd display area for displaying map information and a 4-th display area for displaying visual information, and thus (i-3) supporting at least part of the 1-st player to acquire at least part of the (1_1)-st supply item and the (1_2)-nd supply item contained the 1-st type supply box; and (ii) a process of (ii-1) providing at least part of the information on the specific supply box forwarding timing and the 2-nd type supply box forwarding spot to at least part of the plurality of players according to any one of the (2_2)-nd mode to the (2_4)-th mode, (ii-2) supporting at least part of the plurality of players to display at least part of information on the specific supply box forwarding timing and the 2-nd type supply box forwarding spot through at least part of the 1-st display area, the 2-nd display area, the 3-rd display area and the 4-th display area, and thus (ii-3) supporting at least part of the plurality of players to acquire at least part of the (2_1)-st supply item and the (2_2)-nd supply item contained the 2-nd type supply box.

6. The method of claim 1, wherein, at the step of (a), on condition that metadata on at least part of a 1-st weight applied to the elapsed time information, a 2-nd weight applied to the player battle power information, a 3-rd weight applied to the area phase information, a 4-th weight applied to the cardinal number of the surviving players and a 5-th weight applied to the possessed item of the surviving players are managed, the server acquires weighted specific game-progression degree by applying at least part of the 1-st weight to the 5-th weight to at least part of specific elapsed time information, specific player battle power information, specific area phase information, specific cardinal number of the surviving players and a specific possessed item of a specific surviving player, and confirms the specific supply box forwarding timing candidates and specific timing probabilities corresponding thereto, wherein the specific supply box forwarding timing candidates match with the weighted specific game-progression degree.

7. The method of claim 6, wherein, at the step of (a), the server determines a specific factor whose rate of change in a specific time section is more than or equal to a threshold rate of change among total factors comprised of the player battle power information, the area phase information, the cardinal number of the surviving players and the possessed item of the surviving players, wherein the specific time section corresponds to a specific timing when the specific game-progression degree is acquired among a predetermined plurality of time sections, and the server sets a specific weight corresponding to the specific factor to be greater than other weights corresponding to other factors, wherein said other factors are factors excluding the specific factor among the total factors.

8. The method of claim 1, wherein, at the step of (a), the game-progression degree is calculated by the progress calculating function having arguments of at least part of (i) the elapsed time information, (ii) the player battle power information, (iii) the area phase information, (iv) the cardinal number of the surviving players, (v) the possessed item of the surviving players, (vi) location distribution information of the supply box previously forwarded in the field in the battle royale game and (vii) location distribution information of the surviving players, and in response to determining that the specific game-progression degree acquired by the progress calculating function in real-time in the 2-nd state satisfies the preset condition, the game server confirming the specific supply box forwarding timing candidates and the specific timing probabilities corresponding thereto.

9. The method of claim 1, wherein, at the step of (b), the server (i) determines a 1-st surviving player group to an n-th surviving player group by further referring to at least part of class information on a class applied to a specific surviving player and a specific possessed item of the specific surviving player, and (ii) forwards each of a 1-st matching supply box to an n-th matching supply box matching to each of the 1-st surviving player group to the n-th surviving player group to each of a 1-st supply box forwarding spot to an n-th supply box forwarding spot determined based on locations of each of the 1-st surviving player group to the n-th surviving player group at each of a 1-st specific supply box forwarding timing to an n-th specific supply box forwarding timing, wherein each of the 1-st supply box forwarding spot to the n-th supply box forwarding spot is calculated by each of a predetermined (2_1)-st function to a predetermined (2_n)-th function, wherein the predetermined (2_1)-st function has arguments of at least part of the area metadata, playing locations of at least part of the 1-st surviving player group on a 1-st map and a 1-st designated location by at least part of the 1-st surviving player group and the predetermined (2_n)-th function has arguments of at least part of the area metadata, playing locations of at least part of the n-th surviving player group on an n-th map and an n-th designated location by at least part of the n-th surviving player group, and wherein each of the 1-st specific supply box forwarding timing to the n-th specific supply box forwarding timing is calculated by each of a predetermined (1_1)-st function to a predetermined (1_n)-th function, wherein the predetermined (1_1)-st function has arguments of a 1-st specific supply box forwarding timing candidates and 1-st specific timing probabilities corresponding thereto and the predetermined (1_2)-nd function has arguments of an n-th specific supply forwarding timing candidates and n-th specific timing probabilities corresponding thereto, and (iii) provides at least part of information on the 1-st supply box forwarding spot to the n-th supply box forwarding spot and the 1-st specific supply box forwarding timing and the n-th specific supply box forwarding timing to at least part of the 1-st surviving player group to the n-th surviving player group, thereby supporting at least part of the 1-st surviving player group to the n-th surviving player group to acquire the supply item.

10. The method of claim 1, wherein, at the step of (b), the server forwards the supply box to the supply box forwarding spot at the specific supply box forwarding timing, wherein (i) a first item probability that a class synergy item among the supply items is contained in the supply box in case a ratio of at least one specific factor among total factors comprised of specific elapsed time information, specific player battle power information, specific area phase information, specific cardinal number of surviving players and a specific possessed item of a specific surviving player acquired in real-time is more than a specific threshold is greater than (ii) a second item probability that the class synergy item is contained in the supply box in case the ratio of the specific factor among the total factor is less than the threshold,
wherein the specific threshold is determined corresponding to the specific supply box forwarding timing, and wherein the class synergy item is an item of which a performance is improved when used by a k-th specific surviving player to whom a k-th class is applied among classes applied to the surviving players, and is determined based on class information on the class applied to the specific surviving player and information on the specific possessed item of the specific surviving player.

11. A server for providing a battle royale game which forwards a supply box, comprising:
at least one memory that stores instructions; and
at least one processor configured to execute the instructions to perform or support another device to perform processes of: (I) on condition that each of supply box forwarding timing candidates for each of game-progression degrees and each of timing probabilities corresponding thereto are set and managed, each of the game-progression degrees is calculated by using a progress calculating function having arguments of at least part of (i) elapsed time information which represents a time elapsed after the battle royale game enters the 2-nd state, (ii) player battle power information which represents a battle power of at least part of the plurality of players, (iii) area phase information which represents a state of a safe area and a dangerous area being changed according to area metadata, (iv) a cardinal number of surviving players among the plurality of players and (v) possessed item of the surviving players, in response to determining that specific game-progression degree acquired by the progress calculating function in real-time in the 2-nd state satisfies a preset condition, confirming specific supply box forwarding timing candidates and specific timing probabilities corresponding thereto, wherein the specific supply box forwarding timing candidates match with the specific game-progression degree; and (II) forwarding the supply box to a supply box forwarding spot at a specific supply box forwarding timing, to thereby support at least part of the plurality of players to acquire at least one supply item contained in the supply box, wherein the specific supply box forwarding timing is calculated by a predetermined 1-st function having arguments of the specific supply box forwarding timing candidates and the specific timing probabilities and wherein the supply box forwarding spot is calculated by a predetermined 2-nd function having arguments of at least part of the area metadata, playing locations of at least part of the players on a map, and designated locations by at least part of the players.

12. The server of claim 11, wherein, at the process of (II), the processor forwards at least part of a 1-st type supply box and a 2-nd type supply box to at least part of a 1-st type supply box forwarding spot and a 2-nd type supply box forwarding spot at the specific supply box forwarding timing, to thereby support at least one 1-st player among the plurality of players to acquire at least part of a (1_1)-st supply item and a (1_2)-nd supply item contained in the 1-st type supply box, or support at least part of the plurality of players to acquire at least part of a (2_1)-st supply item and a (2_2)-nd supply item contained in the 2-nd type supply box, wherein the 1-st type supply box contains at least part of the (1_1)-st supply item determined by the 1-st player in the 1-st state and the (1_2)-nd supply item determined by the 1-st player in the 2-nd state, and wherein the 2-nd type supply box contains at least part of the (2_1)-st supply item determined by the server in the 1-st state and the (2_2)-nd supply item determined by the server in the 2-nd state, and wherein each of the 1-st type supply box and the 2-nd type supply box is forwarded to each of the 1-st type supply box forwarding spot and the 2-nd type supply box forwarding spot defined as the supply box forwarding spot by the predetermined 2-nd function having arguments of at least part of the area metadata, the playing locations of at least part of the players on the map and the designated locations by at least part of the players.

13. The server of claim 12, wherein the 1-st type supply box contains, as the supply item, at least part of a (1_1)-st class synergy item determined by the first player in the 1-st state and a (1_2)-nd class synergy item determined by the first player in the 2-nd state among 1-st class synergy items corresponding to a 1-st class applied to the 1-st player, wherein the 1-st class synergy item is an item of which a performance is improved when used by the 1-st player to whom the 1-st class applies among at least one class which applies to the plurality of players, and
wherein the 2-nd type supply box contains at least part of a (2_1)-st item determined by the server in the 1-st state and a (2_2)-nd item determined by the server in the 2-nd state, among items used in the battle royale game, based on at least part of specific elapsed time information, specific player battle power information, specific area phase information, a specific cardinal number of surviving players and a specific possessed item of a specific surviving player.

14. The server of claim 12, wherein, at the process of (II), the processor performs at least part of (i) a process of forwarding the 1-st type supply box to the 1-st type supply box forwarding spot at the specific supply box forwarding timing, and (i-1) supporting at least part of the 1-st player to acquire at least part of the (1_1)-st supply item and the (1_2)-nd supply item contained the 1-st type supply box according to a (1_1)-st mode in which information on the specific supply box forwarding timing and the 1-st type supply box forwarding spot is not provided to the 1-st player; or (i-2) supporting at least part of the 1-st player to acquire at least part of the (1_1)-st supply item and the (1_2)-nd supply item contained the 1-st type supply box by providing information on the specific supply box forwarding timing to at least part of the 1-st player according to a (1_2)-nd mode in which the information on the specific supply box forwarding timing is provided to at least part of the 1-st player; or (i-3) supporting at least part of the 1-st player to acquire at least part of the (1_1)-st supply item and the (1_2)-nd supply item contained the 1-st type supply box by providing the information on the 1-st type supply box forwarding spot to at least part of the 1-st player according to a (1_3)-rd mode in which the information on the 1-st type supply box forwarding spot is provided to at least part of the 1-st player; or (i-4) supporting at least part of the 1-st player to acquire at least part of the (1_1)-st supply item and the (1_2)-nd supply item contained the 1-st type supply box by providing information on the specific supply box forwarding timing and the 1-st type supply box forwarding spot to at least part of the 1-st player according to a (1_4)-th mode in which the information on the specific supply box forwarding timing and the 1-st type supply box forwarding spot is provided to at least part of the 1-st player; and (ii) a process of forwarding the 2-nd type supply box to the 2-nd type supply box forwarding spot at the specific supply box forwarding timing, and (ii-1) supporting the plurality of players to acquire at least part of the (2_1)-st supply item and the (2_2)-nd supply item contained in the 2-nd type supply box according to a (2_1)-st mode in which the information on the specific supply box forwarding timing and the 2-nd type supply box forwarding spot is not provided to the plurality of players; or (ii-2) supporting at least part of the plurality of players to acquire at least part of the (2_1)-st supply item and the (2_2)-nd supply item contained in the 2-nd type supply box by providing the information on the specific supply box forwarding timing to at least part of the plurality of players according to a (2_2)-nd mode in which the information on the specific supply box forwarding timing is provided to at least part of the plurality of players; or (ii-3) supporting at least part of the plurality of players to acquire at least part of the (2_1)-st supply item and the (2_2)-nd supply item contained the 2-nd type supply box by providing the information on the 2-nd type supply box forwarding spot to at least part of the plurality of players according to (2_3)-rd mode in which the information on the 2-nd type supply box forwarding spot is provided to at least part of the plurality of players; or (ii-4) supporting at least part of the plurality of players to acquire at least part of the (2_1)-st supply item and the (2_2)-nd supply item contained the 2-nd type supply box by providing information on the specific supply box forwarding timing and the 2-nd type supply box forwarding spot to at least part of the plurality of players according to (2_4)-th mode in which the information on the specific supply box forwarding timing and the 2-nd type supply box forwarding spot is provided to at least part of the plurality of players.

15. The server of claim 14, wherein, at the process of (II), the processor performs at least part of (i) a process of (i-1) providing at least part of the information on the specific supply box forwarding timing and the 1-st type supply box forwarding spot to at least part of the 1-st player according to any one of the (1_2)-nd mode to the (1_4)-th mode, (i-2) supporting at least part of the 1-st player to display at least part of the information on the specific supply box forwarding timing and the 1-st type supply box forwarding spot through at least part of a 1-st display area for displaying azimuth information, a 2-nd display area for displaying field information, a 3-rd display area for displaying map information and a 4-th display area for displaying visual information, and thus (i-3) supporting at least part of the 1-st player to acquire at least part of the (1_1)-st supply item and the (1_2)-nd supply item contained the 1-st type supply box; and (ii) a process of (ii-1) providing at least part of the information on the specific supply box forwarding timing and the 2-nd type supply box forwarding spot to at least part of the plurality of players according to any one of the (2_2)-nd mode to the (2_4)-th mode, (ii-2) supporting at least part of the plurality of players to display at least part of information on the specific supply box forwarding timing and the 2-nd type supply box forwarding spot through at least part of the 1-st display area, the 2-nd display area, the 3-rd display area and the 4-th display area, and thus (ii-3) supporting at least part of the plurality of players to acquire at least part of the (2_1)-st supply item and the (2_2)-nd supply item contained the 2-nd type supply box.

16. The server of claim 11, wherein, at the process of (I), on condition that metadata on at least part of a 1-st weight applied to the elapsed time information, a 2-nd weight applied to the player battle power information, a 3-rd weight applied to the area phase information, a 4-th weight applied to the cardinal number of the surviving players and a 5-th weight applied to the possessed item of the surviving players are managed, the server acquires weighted specific game-progression degree by applying at least part of the 1-st weight to the 5-th weight to at least part of specific elapsed time information, specific player battle power information, specific area phase information, specific cardinal number of the surviving players and a specific possessed item of a specific surviving player, and confirms the specific supply box forwarding timing candidates and specific timing probabilities corresponding thereto, wherein the specific supply box forwarding timing candidates match with the weighted specific game-progression degree.

17. The server of claim 16, wherein, at the process of (I), the processor determines a specific factor whose rate of change in a specific time section is more than or equal to a threshold rate of change among total factors comprised of the player battle power information, the area phase information, the cardinal number of the surviving players and the possessed item of the surviving players, wherein the specific time section corresponds to a specific timing when the specific game-progression degree is acquired among a predetermined plurality of time sections, and the server sets a specific weight corresponding to the specific factor to be greater than other weights corresponding to other factors, wherein said other factors are factors excluding the specific factor among the total factors.

18. The server of claim 11, wherein, at the process of (I), the game-progression degree is calculated by the progress calculating function having arguments of at least part of (i) the elapsed time information, (ii) the player battle power information, (iii) the area phase information, (iv) the cardinal number of the surviving players, (v) the possessed item of the surviving players, (vi) location distribution information of the supply box previously forwarded in the field in the battle royale game and (vii) location distribution information of the surviving players, and in response to determining that the specific game-progression degree acquired by the progress calculating function in real-time in the 2-nd state satisfies the preset condition, the game server confirming the specific supply box forwarding timing candidates and the specific timing probabilities corresponding thereto.

19. The server of claim 11, wherein, at the process of (II), the processor (i) determines a 1-st surviving player group to an n-th surviving player group by further referring to at least part of class information on a class applied to a specific surviving player and a specific possessed item of the specific surviving player, and (ii) forwards each of a 1-st matching supply box to an n-th matching supply box matching to each of the 1-st surviving player group to the n-th surviving player group to each of a 1-st supply box forwarding spot to an n-th supply box forwarding spot determined based on locations of each of the 1-st surviving player group to the n-th surviving player group at each of a 1-st specific supply box forwarding timing to an n-th specific supply box forwarding timing, wherein each of the 1-st supply box forwarding spot to the n-th supply box forwarding spot is calculated by each of a predetermined (2_1)-st function to a predetermined (2_n)-th function, wherein the predetermined (2_1)-st function has arguments of at least part of the area metadata, playing locations of at least part of the 1-st surviving player group on a 1-st map and a 1-st designated location by at least part of the 1-st surviving player group and the predetermined (2_n)-th function has arguments of at least part of the area metadata, playing locations of at least part of the n-th surviving player group on an n-th map and an n-th designated location by at least part of the n-th surviving player group, and wherein each of the 1-st specific supply box forwarding timing to the n-th specific supply box forwarding timing is calculated by each of a predetermined (1_1)-st function to a predetermined (1_n)-th function, wherein the predetermined (1_1)-st function has arguments of a 1-st specific supply box forwarding timing candidates and 1-st specific timing probabilities corresponding thereto and the predetermined (1_2)-nd function has arguments of an n-th specific supply forwarding timing candidates and n-th specific timing probabilities corresponding thereto, and (iii) provides at least part of information on the 1-st supply box forwarding spot to the n-th supply box forwarding spot and the 1-st specific supply box forwarding timing and the n-th specific supply box forwarding timing to at least part of the 1-st surviving player group to the n-th surviving player group, thereby supporting at least part of the 1-st surviving player group to the n-th surviving player group to acquire the supply item.

20. The server of claim 11, wherein, at the process of (II), the processor forwards the supply box to the supply box forwarding spot at the specific supply box forwarding timing, wherein (i) a first item probability that a class synergy item among the supply items is contained in the supply box in case a ratio of at least one specific factor among total factors comprised of specific elapsed time information, specific player battle power information, specific area phase information, specific cardinal number of surviving players and a specific possessed item of a specific surviving player acquired in real-time is more than a specific threshold is greater than (ii) a second item probability that the class synergy item is contained in the supply box in case the ratio of the specific factor among the total factor is less than the threshold,
wherein the specific threshold is determined corresponding to the specific supply box forwarding timing, and wherein the class synergy item is an item of which a performance is improved when used by a k-th specific surviving player to whom a k-th class is applied among classes applied to the surviving players, and is determined based on class information on the class applied to the specific surviving player and information on the specific possessed item of the specific surviving player.
